(19) United States
(12) Patent Application Publication
(10) Pub. No.: US 2008/0240242 A1
(43) Pub. Date: Oct. 2, 2008

(54) Method and system for motion vector predictions

(75) Inventor: Jani Lainema, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/728,952

(22) Filed: Mar. 27, 2007

(51) Int. Cl. H04N 11/04

(52) U.S. Cl. 375/240.16; 375/E07.026

(57) ABSTRACT

A video coding system is capable of encoding and/or decoding a video frame based on at least two different types of motion vector predictions. In one type, the motion vector predictor of a current block in the video frame is calculated using only the motion vector of a neighboring block which is directly above the current block. In another type, the motion vector predictor is calculated using the motion vector of a neighboring block which is located on the left side of the current block. In the former type, adjacent blocks located in the same row can be decoded independently of each other. In the latter type, adjacent blocks located in the same column can be decoded independently. The system may also be capable of conventional coding. An indication is used for indicating to the decoder side which type of motion vector predictor is used in the encoding.

### FIELD OF THE INVENTION

The present invention relates generally to the encoding and decoding of digital video materials and, more particularly, to a method and system for motion vector predictions suitable for efficient parallel computation structures.

### BACKGROUND OF THE INVENTION

This section is intended to provide a background or context. The description herein may include concepts that could be pursued, but are not necessarily ones that have been previously conceived or pursued. Therefore, unless otherwise indicated herein, what is described in this section is not prior art to the claims in this application and is not admitted to be prior art by inclusion in this section.

A video codec comprises of an encoder that transforms an input video into a compressed representation suitable for storage/transmission and a decoder that can uncompress the compressed video representation back into a viewable form. Typically, the encoder discards some information in the original video sequence in order to represent the video in a more compact form (that is, at lower bitrate).

Typical hybrid video codecs, for example ITU-T H.263 and H.264, encode the video information in two phases. First, pixel values in a certain picture area (or “block”) are predicted, for example, by a motion compensation means or by a spatial prediction means. The motion compensation means is used for finding and indicating an area in one of the previously coded video frames that corresponds closely to the block being coded. The spatial prediction means uses the pixel values around the block to be coded in a specified manner. Second, the prediction error, i.e. the difference between the predicted block of pixels and the original block of pixels, is coded. This is typically done by transforming the difference in pixel values, residual information, using a specified transform (Discreet Cosine Transform (DCT), for example, or a variant of it), quantizing the transform coefficients and entropy coding the resulting quantized coefficients. The encoder can control the balance between the accuracy of the pixel representation (picture quality) and size of the resulting coded video representation (file size or transmission bitrate), by varying the fidelity of the quantization process.

The decoder reconstructs the output video by applying a prediction means similar to that in the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying the prediction and the prediction error decoding means, the decoder sums up the prediction and prediction error signals (pixel values) to form the output video frame. The decoder and encoder can also apply an additional filtering means to improve the quality of the output video before passing it for display and/or storing it as prediction reference for the subsequent frames in the video sequence.

In typical video codecs the motion information is indicated with motion vectors associated with each motion compensated image block. In the encoder side, each of these motion vectors represents the displacement of the image block in the picture to be coded and the prediction source block in one of the previously coded pictures. In the decoder side, each of these motion vectors represents the displacement of the image block in the picture to be decoded and the prediction source block in one of the previously decoded pictures. In order to represent motion vectors efficiently, motion vectors are typically coded differentially with respect to the block-specific predictive motion vectors. In a typical video codec, the predictive motion vectors are created in a predefined way, for example, calculating the median of the encoded or decoded motion vectors of the adjacent blocks.

Typical video encoders utilize Lagrangian cost functions to find optimal Macroblock mode and motion vectors. This kind of cost function uses a weighting factor λ to tie together the exact or estimated image distortion due to lossy coding methods and the exact or estimated amount of information that is required to represent the pixel values in an image area:

C=D+λR

Where C is the Lagrangian cost to be minimized, D is the image distortion (e.g. Mean Squared Error) with the mode and motion vectors considered, and R the number of bits needed to represent the required data to reconstruct the image block in the decoder (including the amount of data to represent the candidate motion vectors).

In computationally optimized video encoder implementations some of the encoding is typically performed in parallel with other operations. Because of the computationally intensive nature of the motion estimation procedure, this functionality is quite often separated from the rest of the encoding and implemented, for example, by a separate hardware module or run on a different CPU than the other encoding functions. In this kind of typical encoder architecture the motion estimation for one Macroblock takes place simultaneously with the prediction error coding and mode selection for the earlier Macroblock.

The problem in this scenario is that due to differential coding of motion vectors with respect to predictive motion vectors derived from the motion vectors of the Macroblocks coded earlier, the optimal motion vector search is dependent on the Macroblock mode and motion vector selection of the previous Macroblock. However, this information is available only after the Macroblock mode and motion vector selection for the previous Macroblock is carried out and thus cannot be utilized in motion estimation taking place parallel to the mode selection process.

It is thus desirable to provide a method for motion vector predictions that allows parallel implementations without suffering from sub-optimal performance.

### SUMMARY OF THE INVENTION

The first aspect of the present invention provides a video coding method for encoding and/or decoding a video frame based on at least two different types of motion vector predictions. In one type, the motion vector predictor of a block in the video frame is calculated using at least the motion vector of a neighboring block which is located in a row different from the row in which the current block is located. As such, adjacent blocks located in the same row can be decoded independently of each other. In another type, the motion vector predictor is calculated using only the motion of a neighboring block which is located in a column different from the column in which the current block is located. As such, adjacent blocks located in the same column can be decoded independently of each other. Additionally, a different type of motion vector prediction can be used. In this differently type, the motion vector of a neighboring block which is located on the left side of the current block and the motion vectors of other neighboring blocks in a different row can also be used in the motion vector predictor calculation. An indication may be provided to the decoder side, indicating which type of motion vector predictor is used in the encoding process.

The second aspect of the present invention provides the apparatus for carrying out the above method.

The third aspect of the present invention provides a software product embodied in a computer readable storage medium having computer codes for carried out the above method.

The fourth aspect of the present invention provides an electronic device, such as a mobile terminal, having a video encoder and/or decoder as described above.

### BRIEF DESCRIPTION OF THE DRAWINGS

FIG. 1a illustrates predictive motion vectors for blocks X and Y used for motion vector prediction in the case of median prediction in prior art.

FIG. 2a illustrates predictive motion vectors for blocks X and Y used for motion vector prediction, according to one embodiment of the present invention.

FIG. 2b illustrates predictive motion vectors for blocks X and Y used for motion vector prediction, according to another embodiment of the present invention.

FIG. 2c illustrates predictive motion vectors for blocks X and Y used for motion vector prediction, according to yet another embodiment of the present invention.

FIG. 3 shows a typical encoder.

FIG. 4 shows a typical decoder.

FIG. 5 shows an encoder, according to the present invention.

FIG. 6 shows a decoder, according to the present invention.

FIG. 7 illustrates a cellular communication interface system that can be used for encoding and/or decoding video frames, according to the present invention.

### DETAILED DESCRIPTION OF THE INVENTION

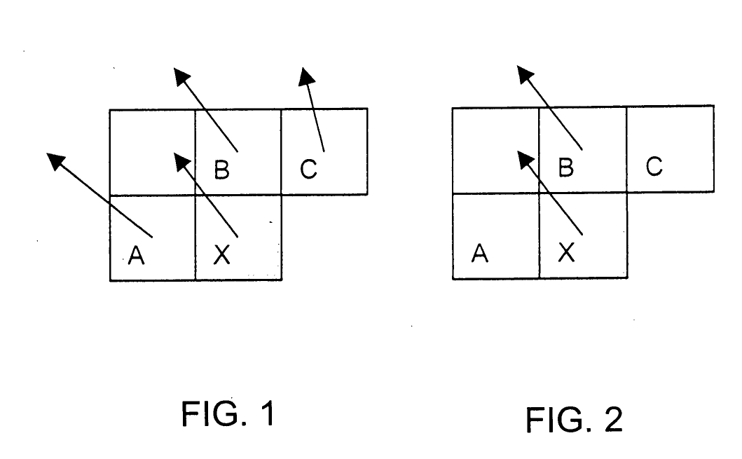

In a typical codec, such as H.264, the predictive motion vector for a block to be coded is usually calculated using motion vectors of its neighboring blocks (neighboring motion vectors) as a median of these vectors. As shown in FIG. 1, the current block X and a subsequent block Y are the blocks to be coded. The motion vectors of the neighboring blocks A, B and C are used to calculate the predictive motion vector for block X and the motion vectors of blocks X, C and F are used to calculate the predictive motion vector for block Y. The motion vector of each block is shown as an arrow associated with that block. Thus, in order to obtain the predictive motion vector for the current block X, the motion vector of Macroblock A must be known. Similarly, in order to obtain the predictive motion vector for block Y, the motion vector of block X must be known. Thus, the predictive motion vector for block Y cannot be obtained before the predictive motion vector for block X has been obtained.

Similar approach is applied to Intra prediction and entropy coding of the block. In order to be able to Intra predict the current block, the pixel values of the neighboring block on the left side of the current block need to be available. Similarly in order to be able to entropy code or decode the data associated with the current block the block to the left need to be already processed due to the dependencies in entropy coding of data items.

According to one embodiment of the present invention, a different type of motion vector prediction is also used. According to the present invention, neighboring blocks X and Y can be decoded independently of each other. As shown in FIG. 2a, the motion vector of the current block X is calculated, for example, only using the motion vector of the Macroblock B, directly above the block X. Similarly, the motion vector of the subsequent block Y is calculated only using the motion vector of the Macroblock C. This type of motion vector prediction, does not rely on the motion vectors of the neighboring Macroblocks on the left side of block X or block Y. When two or more types of motion vector prediction are provided as motion vector prediction possibilities and at least one of the types is not dependent from the motion vectors of the left side neighboring Macroblock, it is possible to build an encoder and a decoder in a way that motion estimation and compensation can be carried out concurrently for the same row of Macroblocks. This is because the motion vector of one Macroblock depends only on the motion vectors of Macroblocks above. As such, efficient parallel encoder implementations are possible. Together with the flexibility of traditional motion vector prediction methods, the compression efficiency for both parallel and sequential implementations can be maximized.

According to one embodiment of the present invention, two or more motion vector predictive types as provided as selection possibilities and one or more of those possibilities are selected for coding. Accordingly, an indication of the selected motion vector prediction type or types is sent to the decoder side so that the encoded video can be decoded based on the indication. At least one of the possible motion vector prediction types is not dependent from the motion vectors of the left side neighboring Macroblock. In other words, at least one of the possible motion vector prediction types calculates the predictive motion vector of a current Macroblock using only the motion vector of at least one of the Macroblocks in the same row, above the current Macroblock.

In one embodiment of the present invention, a video decoder is defined with two methods to generate motion vector prediction for the blocks to be decoded:

Method 1: Motion vector prediction where at least the motion vector of a block on the left side of the current block is used for motion vector prediction; and

Method 2: Utilizing the motion vector of the block directly above to the current block to as the motion vector prediction.

Accordingly, the decoder contains the intelligence to detect which method is used for each of the motion blocks and use the selected method to generate a predicted motion vector for each block associated with motion information.

The present invention can be implemented in various ways:
More than two motion vector prediction methods can be utilized;
The selection between different motion vector prediction methods can be embedded to the video information (for example, in the slice headers or parameter sets) or provided as out-of-band information;
Motion vector prediction methods can be based on multiple or single motion vectors;
Motion vector prediction methods can be based on motion vectors of neighboring or non-neighboring motion blocks;
Motion vector prediction methods can be based on motion vectors of the same or different pictures;
Motion vector prediction methods can utilize other signaled information (e.g. selection of the most suitable candidate motion vectors and how to derive the motion vector prediction from those);
Motion vector prediction methods can be based on any combination of the alternatives above;
The same approach can be utilized for other data having similar dependencies on Macroblock level (e.g. disabling the Intra prediction and/or the contexts used in entropy coding from Macroblock directly to the left from the one being encoded or decoded).

In another embodiment of the present invention, as shown in FIG. 2b, the motion vector of block X is calculated, for example, only using the motion vector of the Macroblock A, directly located on the left side of block X. For another block Y located on the same column as block X, the motion vector is calculated only using the motion vector the Macroblock D, which is directly located on the left side of the block Y. Since the motion vector of block X is not used for predicting the motion vector of block Y, block Y can be decoding independently of block X.

In yet another embodiment of the present invention, as shown in FIG. 2c, the motion vector of block X is calculated, for example, only using the motion vector of the Macroblock E, which is located on the upper left side of block X. For another block Y located on the same row as block X, the motion vector is calculated only using the motion vector of the Macroblock B, which is located on the upper left side of the block Y. Since the motion vector of block X is not used for predicting the motion vector of block Y, block Y can be decoding independently of block X. In a different embodiment, the motion vector of block X can be calculated using the motion vectors of blocks E and B, whereas the motion vector of block Y is calculated using the motion vectors of block B and C.

Thus, according to various embodiments of the present invention, the method of decoding an encoding video signal is involved in retrieving in the encoded video signal a motion prediction method indicator indicating whether a first block and a second block in a video frame can be decoded independently. If so, the first motion vector predictor of the first block is calculated based on a motion vector of at least one surrounding block of the first block so as to reconstruct the motion vector for the first block based on the first motion vector predictor. Likewise, the second motion vector predictor of the second block is calculated based on a motion vector of at least one surrounding block of the second block, wherein the second motion vector predictor is independent of the reconstructed motion vector for the first block. Accordingly, the motion prediction operation of the first and second blocks is performed independently of each other.

The method of encoding a video signal, according to the present invention, is involved in selecting a motion prediction method in which a first block and a second block can be decoded independently and performing motion prediction operation for the first and second block independently of each other. Thus, the first motion predictor of the first block is calculated based on a motion vector of at least one surrounding block of the first block and the second motion vector predictor of the second block is calculated based on a motion vector of at least one surrounding block of the second block, wherein the second motion vector predictor is independent of the motion vector for the first block reconstructed based on the first vector motion predictor. The first and second motion vector predictors are encoded into the encoded video signal.

As can be seen from FIGS. 2a and 2c, when the first block and the second block are located in the same row, their surrounding blocks are located in a different row. As can be seen from FIG. 2b, when the first block and the second block are located in the same column, their surrounding blocks are located in different column.

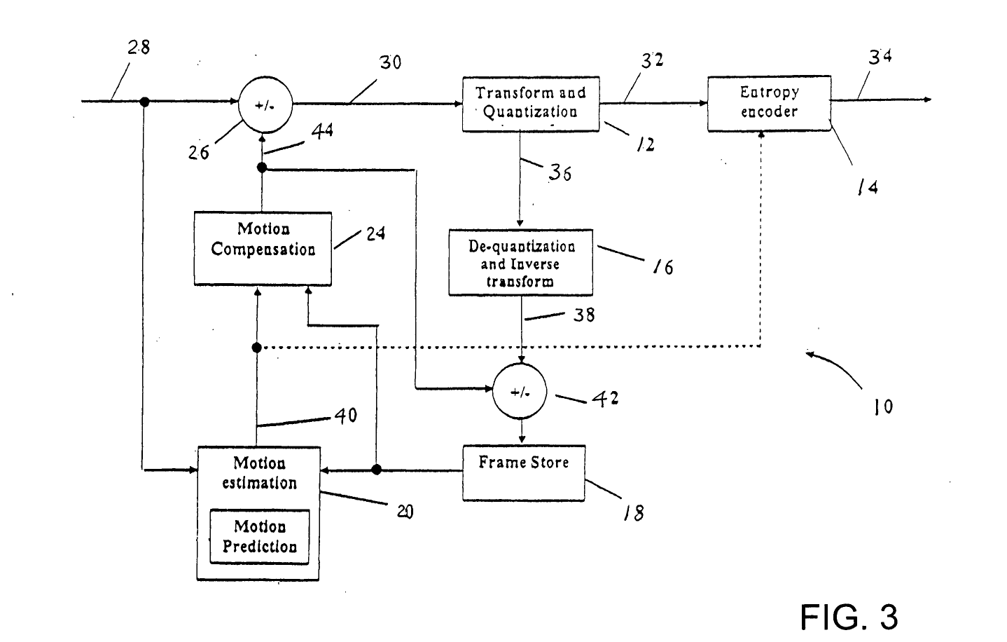

FIG. 3 is a block diagram showing a traditional encoder. As shown in FIG. 3, the encoder 10 receives input signals 28 indicating an original frame and provides signals 34 indicating encoded video data to a transmission channel (not shown). The encoder 10 includes a motion estimation block 20 to generate predictive motion vector for the current block based on a median of the motion vectors in the neighboring blocks. Resulting motion data 40 is passed to a motion compensation block 24. The motion compensation block 24 forms a predicted image 44. As the predicted image 44 is subtracted from the original frame by a combining module 26, the residuals 30 are provided to a transform and quantization block 12 which performs transformation and quantization to reduce the magnitude of the data and send the quantized data 32 to a de-quantization and inverse transform block 16 and an entropy coder 14. A reconstructed frame is formed by combining the output from the de-quantization and inverse transform block 16 and the motion compensation block 24 through a combiner 42. After reconstruction, the reconstructed frame may be sent to a frame store 18. The entropy encoder 14 encodes the residual as well as motion data 40 into encoded video data 34.

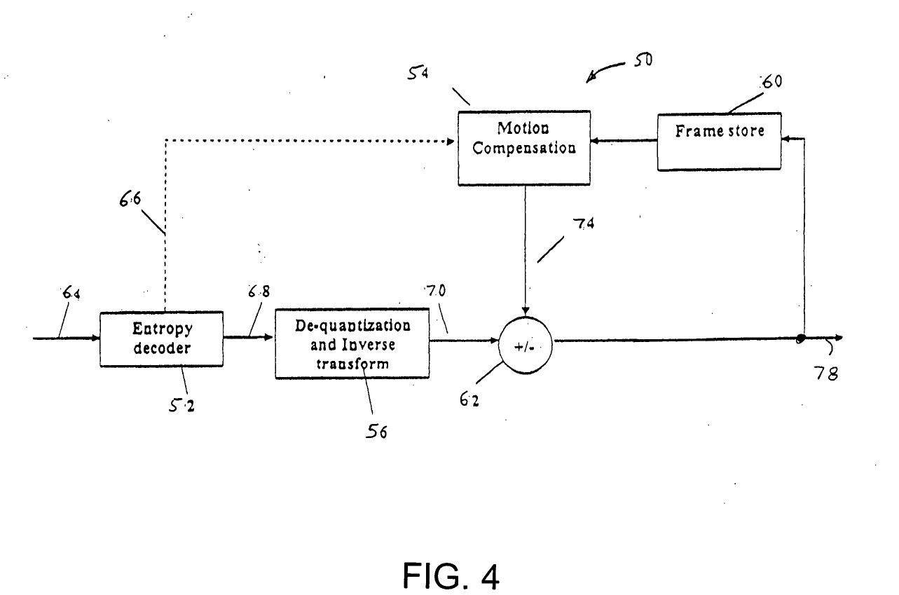

FIG. 4 is a block diagram of a typical video decoder. In FIG. 4, a decoder 50 uses an entropy decoder 52 to decode video data 64 from a transmission channel into decoded quantized data 68. Motion data 66 is also sent from the entropy decoder 52 to a de-quantization and inverse transform block 56. The de-quantization and inverse transform block 56 then converts the quantized data into residuals 60. Motion data 66 from the entropy decoder 52 is sent to the motion compensation block 54 to form predicted images 74. With the predicted image 74 from the motion compensation block 54 and the residuals 70 from the de-quantization and inverse transform block 56, a combination module 62 provides signals 78 that indicate a reconstructed video image.

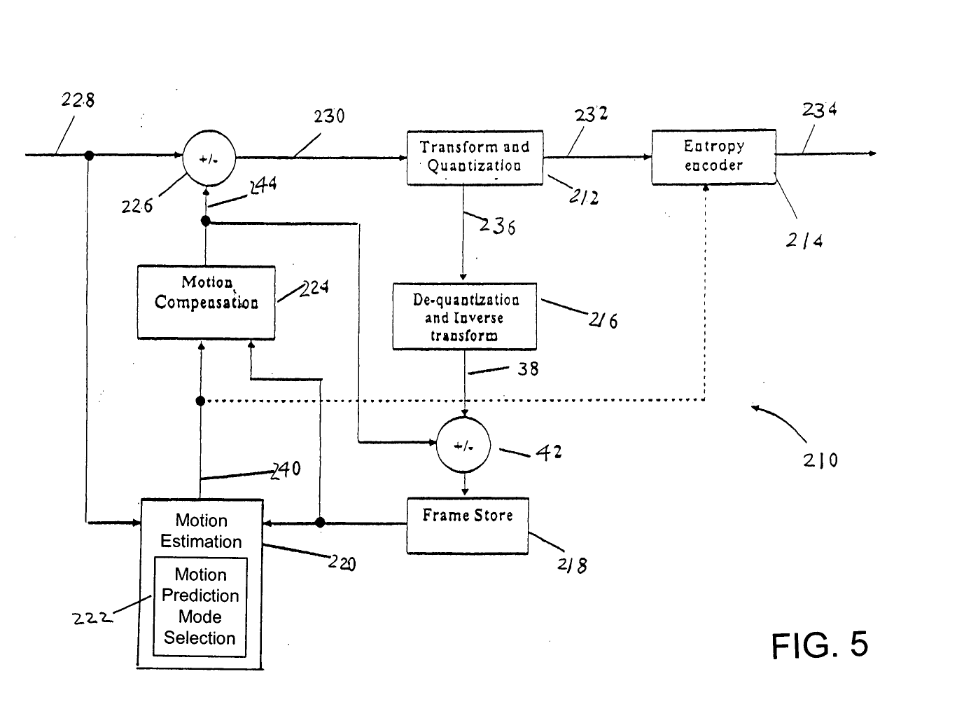

FIG. 5 illustrates an encoder, according to one embodiment of the present invention. As shown in FIG. 5, the encoder 210 receives input signals 228 indicating an original frame and provides signals 234 indicating encoded video data to a transmission channel (not shown). The encoder 210 includes a motion estimation block 220 to generate the predictive motion vector of the current block. The encoder 210 is capable of encoding the input signals in different motion vector prediction types or modes. For mode selection purposes, the motion estimation block 220 includes a motion prediction mode selection module 222 to select the motion prediction type or mode for coding. For example, the selection module 222 can be configured to select the motion prediction type in which the motion vector of the current block is based only on the motion vector of a block directly above the current block (FIG. 2a) or based only on the motion vector of a block directly on the left side of the current block (FIG. 2b). As such, the decoding can be carried for two blocks independently of each other. The selection module 222 can also select the motion prediction type in which the motion vector of the current block is a median of the motion vectors of the neighboring blocks including the block on the left side of the current block and the block directly above the current block (for example, FIG. 1). A software application production is operatively linked to the motion estimation block to carry out the task of motion estimation, for example. Resulting motion data 240 is passed to a motion compensation block 224. The motion compensation block 224 may form a predicted image 244. As the predicted image 244 is subtracted from the original frame by a combining module 226, the residuals 230 are provided to a transform and quantization block 212 which performs transformation and quantization to reduce the magnitude of the data and send the quantized data 232 to a de-quantization and inverse transform block 216 and an entropy coder 214. A reconstructed frame is formed by combining the output from the de-quantization and inverse transform block 16 and the motion compensation block 224 through a combiner 242. After reconstruction, the reconstructed frame may be sent to a frame store 218. The entropy encoder 214 encodes the residual as well as motion data 240 into encoded video data 234. In the bitstream containing the encoded video data 234, an indication of the selected motion vector prediction mode can be embedded as out-of-band information, for example.

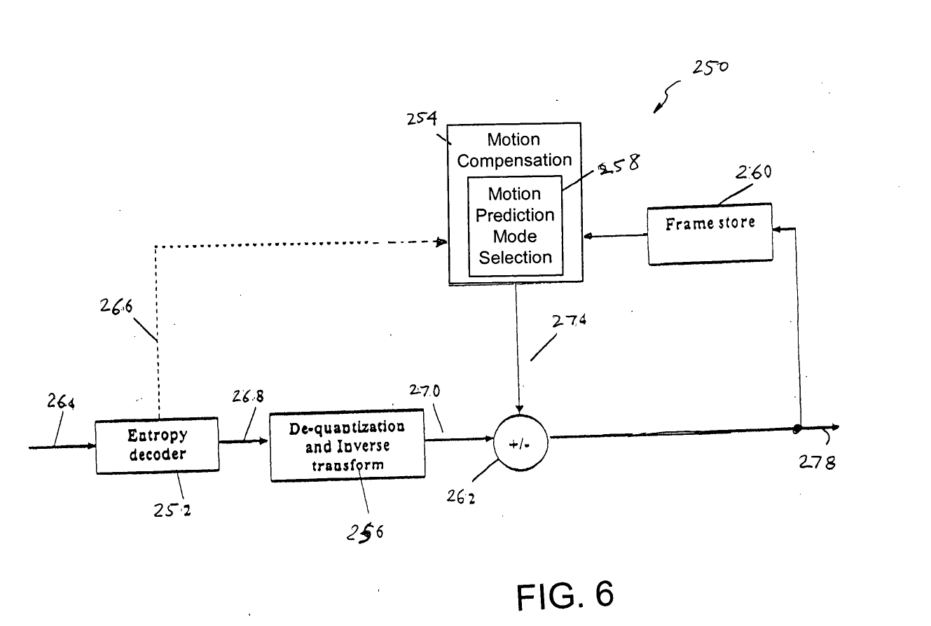

FIG. 6 illustrates a decoder, according to one embodiment of the present invention. In FIG. 6, the decoder 250 uses an entropy decoder 252 to decode video data 264 from a transmission channel into decoded quantized data 268. The entropy decoder 252 may include a software program or a mechanism, for example, to detect from the bitstream that contains the video data 264 what motion vector prediction mode is used for motion compensation. One motion vector prediction mode can be the mode in which two adjacent blocks can be decoded independently of each other.

Motion data 266 is also sent from the entropy decoder 252 to a de-quantization and inverse transform block 256. The de-quantization and inverse transform block 256 then converts the quantized data into residuals 260. Motion data 266 from the entropy decoder 252 is sent to the motion compensation block 254 to form predicted images 274. The decoder 250 may include a motion prediction mode selection module 258 to select the motion vector prediction mode that is used for motion prediction in the encoded data. As such, the motion compensation block 254 can predict the motion accordingly. With the predicted image 274 from the motion compensation block 254 and the residuals 270 from the de-quantization and inverse transform block 256, a combination module 262 provides signals 278 that indicate a reconstructed video image.

As shown in FIGS. 5 and 6, the blocks are encoded in an entropy encoder and decoded in an entropy decoder. If a block is coded in an intra mode, the pixel prediction for each of the pixels in the block is obtained and an indication is used to indicate the pixel prediction.

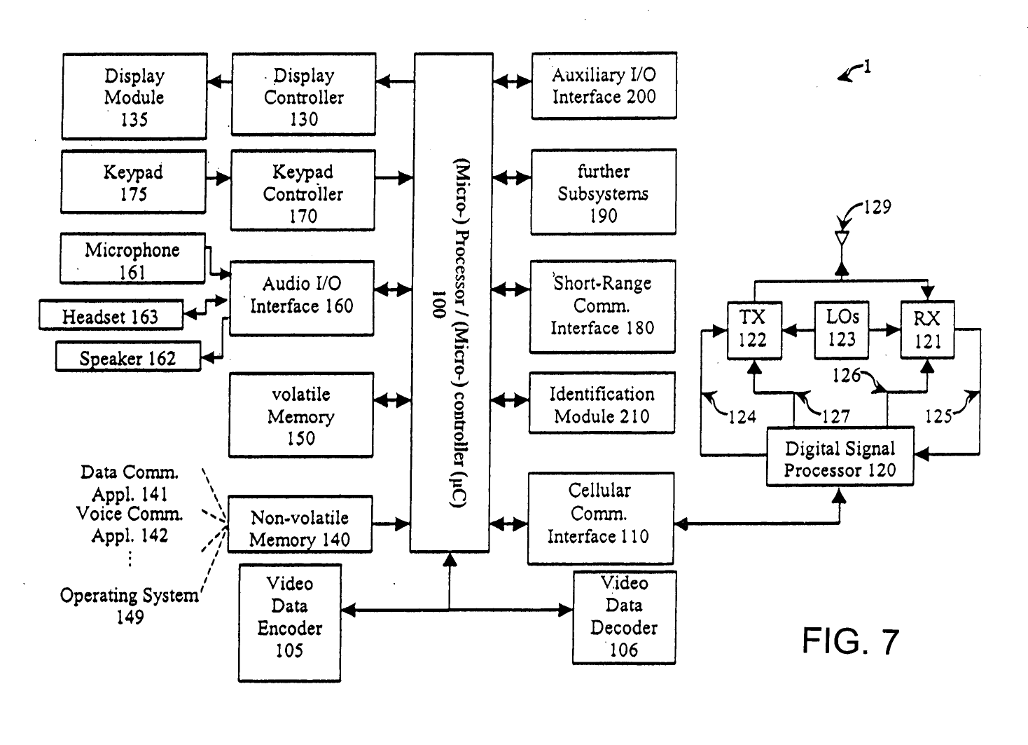

FIG. 7 depicts a typical mobile device according to an embodiment of the present invention. The mobile device 1 shown in FIG. 7 is capable of cellular data and voice communications. It should be noted that the present invention is not limited to this specific embodiment, which represents one of a multiplicity of different embodiments. The mobile device 1 includes a (main) microprocessor or microcontroller 100 as well as components associated with the microprocessor controlling the operation of the mobile device. These components include a display controller 130 connecting to a display module 135, a non-volatile memory 140, a volatile memory 150 such as a random access memory (RAM), an audio input/output (I/O) interface 160 connecting to a microphone 161, a speaker 162 and/or a headset 163, a keypad controller 170 connected to a keypad 175 or keyboard, any auxiliary input/output (I/O) interface 200, and a short-range communications interface 180. Such a device also typically includes other device subsystems shown generally at 190.

The mobile device 1 may communicate over a voice network and/or may likewise communicate over a data network, such as any public land mobile networks (PLMNs) in form of e.g. digital cellular networks, especially GSM (global system for mobile communication) or UMTS (universal mobile telecommunications system). Typically the voice and/or data communication is operated via an air interface, i.e. a cellular communication interface subsystem in cooperation with further components (see above) to a base station (BS) or node B (not shown) being part of a radio access network (RAN) of the infrastructure of the cellular network.

The cellular communication interface subsystem as depicted illustratively in FIG. 7 comprises the cellular interface 110, a digital signal processor (DSP) 120, a receiver (RX) 121, a transmitter (TX) 122, and one or more local oscillators (LOs) 123 and enables the communication with one or more public land mobile networks (PLMNs). The digital signal processor (DSP) 120 sends communication signals 124 to the transmitter (TX) 122 and receives communication signals 125 from the receiver (RX) 121. In addition to processing communication signals, the digital signal processor 120 also provides for the receiver control signals 126 and transmitter control signal 127. For example, besides the modulation and demodulation of the signals to be transmitted and signals received, respectively, the gain levels applied to communication signals in the receiver (RX) 121 and transmitter (TX) 122 may be adaptively controlled through automatic gain control algorithms implemented in the digital signal processor (DSP) 120. Other transceiver control algorithms could also be implemented in the digital signal processor (DSP) 120 in order to provide more sophisticated control of the transceiver 121/122.

In case the mobile device 1 communications through the PLMN occur at a single frequency or a closely-spaced set of frequencies, then a single local oscillator (LO) 123 may be used in conjunction with the transmitter (TX) 122 and receiver (RX) 121. Alternatively, if different frequencies are utilized for voice/data communications or transmission versus reception, then a plurality of local oscillators can be used to generate a plurality of corresponding frequencies.

Although the mobile device 1 depicted in FIG. 7 is used with the antenna 129 as or with a diversity antenna system (not shown), the mobile device 1 could be used with a single antenna structure for signal reception as well as transmission. Information, which includes both voice and data information, is communicated to and from the cellular interface 110 via a data link between the digital signal processor (DSP) 120. The detailed design of the cellular interface 110, such as frequency band, component selection, power level, etc., will be dependent upon the wireless network in which the mobile device 1 is intended to operate.

After any required network registration or activation procedures, which may involve the subscriber identification module (SIM) 210 required for registration in cellular networks, have been completed, the mobile device 1 may then send and receive communication signals, including both voice and data signals, over the wireless network. Signals received by the antenna 129 from the wireless network are routed to the receiver 121, which provides for such operations as signal amplification, frequency down conversion, filtering, channel selection, and analog to digital conversion. Analog to digital conversion of a received signal allows more complex communication functions, such as digital demodulation and decoding, to be performed using the digital signal processor (DSP) 120. In a similar manner, signals to be transmitted to the network are processed, including modulation and encoding, for example, by the digital signal processor (DSP) 120 and are then provided to the transmitter 122 for digital to analog conversion, frequency up conversion, filtering, amplification, and transmission to the wireless network via the antenna 129.

The microprocessor/microcontroller (μC) 110, which may also be designated as a device platform microprocessor, manages the functions of the mobile device 1. Operating system software 149 used by the processor 110 is preferably stored in a persistent store such as the non-volatile memory 140, which may be implemented, for example, as a Flash memory, battery backed-up RAM, any other non-volatile storage technology, or any combination thereof. In addition to the operating system 149, which controls low-level functions as well as (graphical) basic user interface functions of the mobile device 1, the non-volatile memory 140 includes a plurality of high-level software application programs or modules, such as a voice communication software application 142, a data communication software application 141, an organizer module (not shown), or any other type of software module (not shown). These modules are executed by the processor 100 and provide a high-level interface between a user of the mobile device 1 and the mobile device 1. This interface typically includes a graphical component provided through the display 135 controlled by a display controller 130 and input/output components provided through a keypad 175 connected via a keypad controller 170 to the processor 100, an auxiliary input/output (I/O) interface 200, and/or a short-range (SR) communication interface 180. The auxiliary I/O interface 200 comprises especially USB (universal serial bus) interface, serial interface, MMC (multimedia card) interface and related interface technologies/standards, and any other standardized or proprietary data communication bus technology, whereas the short-range communication interface radio frequency (RF) low-power interface includes especially WLAN (wireless local area network) and Bluetooth communication technology or an IRDA (infrared data access) interface. The RF low-power interface technology referred to herein should especially be understood to include any IEEE 801.xx standard technology, which description is obtainable from the Institute of Electrical and Electronics Engineers. Moreover, the auxiliary I/O interface 200 as well as the short-range communication interface 180 may each represent one or more interfaces supporting one or more input/output interface technologies and communication interface technologies, respectively. The operating system, specific device software applications or modules, or parts thereof, may be temporarily loaded into a volatile store 150 such as a random access memory (typically implemented on the basis of DRAM (direct random access memory) technology for faster operation). Moreover, received communication signals may also be temporarily stored to volatile memory 150, before permanently writing them to a file system located in the non-volatile memory 140 or any mass storage preferably detachably connected via the auxiliary I/O interface for storing data. It should be understood that the components described above represent typical components of a traditional mobile device 1 embodied herein in the form of a cellular phone. The present invention is not limited to these specific components and their implementation depicted merely for illustration and for the sake of completeness.

An exemplary software application module of the mobile device 1 is a personal information manager application providing PDA functionality including typically a contact manager, calendar, a task manager, and the like. Such a personal information manager is executed by the processor 100, may have access to the components of the mobile device 1, and may interact with other software application modules. For instance, interaction with the voice communication software application allows for managing phone calls, voice mails, etc., and interaction with the data communication software application enables for managing SMS (soft message service), MMS (multimedia service), e-mail communications and other data transmissions. The non-volatile memory 140 preferably provides a file system to facilitate permanent storage of data items on the device including particularly calendar entries, contacts etc. The ability for data communication with networks, e.g. via the cellular interface, the short-range communication interface, or the auxiliary I/O interface enables upload, download, and synchronization via such networks.

The application modules 141 to 149 represent device functions or software applications that are configured to be executed by the processor 100. In most known mobile devices, a single processor manages and controls the overall operation of the mobile device as well as all device functions and software applications. Such a concept is applicable for today's mobile devices. The implementation of enhanced multimedia functionalities includes, for example, reproducing of video streaming applications, manipulating of digital images, and capturing of video sequences by integrated or detachably connected digital camera functionality. The implementation may also include gaming applications with sophisticated graphics and the necessary computational power. One way to deal with the requirement for computational power, which has been pursued in the past, solves the problem for increasing computational power by implementing powerful and universal processor cores. Another approach for providing computational power is to implement two or more independent processor cores, which is a well known methodology in the art. The advantages of several independent processor cores can be immediately appreciated by those skilled in the art. Whereas a universal processor is designed for carrying out a multiplicity of different tasks without specialization to a pre-selection of distinct tasks, a multi-processor arrangement may include one or more universal processors and one or more specialized processors adapted for processing a predefined set of tasks. Nevertheless, the implementation of several processors within one device, especially a mobile device such as mobile device 1, requires traditionally a complete and sophisticated re-design of the components.

In the following, the present invention will provide a concept which allows simple integration of additional processor cores into an existing processing device implementation enabling the omission of expensive complete and sophisticated redesign. The inventive concept will be described with reference to system-on-a-chip (SoC) design. System-on-a-chip (SoC) is a concept of integrating at least numerous (or all) components of a processing device into a single high-integrated chip. Such a system-on-a-chip can contain digital, analog, mixed-signal, and often radio-frequency functions—all on one chip. A typical processing device comprises a number of integrated circuits that perform different tasks. These integrated circuits may include especially microprocessor, memory, universal asynchronous receiver-transmitters (UARTs), serial/parallel ports, direct memory access (DMA) controllers, and the like. A universal asynchronous receiver-transmitter (UART) translates between parallel bits of data and serial bits. The recent improvements in semiconductor technology cause very-large-scale integration (VLSI) integrated circuits to enable a significant growth in complexity, making it possible to integrate numerous components of a system in a single chip. With reference to FIG. 7, one or more components thereof, e.g. the controllers 130 and 170, the memory components 150 and 140, and one or more of the interfaces 200, 180 and 110, can be integrated together with the processor 100 in a signal chip which forms finally a system-on-a-chip (Soc).

Additionally, the device 1 is equipped with a module for encoding 105 and decoding 106 of video data according to the inventive operation of the present invention. By means of the CPU 100 said modules 105, 106 may individually be used. However, the device 1 is adapted to perform video data encoding or decoding respectively. Said video data may be received by means of the communication modules of the device or it also may be stored within any imaginable storage means within the device 1.

In the device 1, the software applications can be configured to include computer codes to carry out the encoding and/or decoding method, according various embodiments of the present invention.

In sum, the present invention provides a method and apparatus for video coding wherein a motion vector of a block in a video frame is coded based on the motion vectors of the surrounding blocks. The method and apparatus for decoding are involved in means, modules, processors or a software product for:

retrieving a motion prediction method indicator in the encoded video signal, the motion prediction method indicator indicative of whether or not a first block and a second block can be decoded independently;

if it is determined that the first block and the second block can be decoded in independently, the method further comprises:
calculating a first motion vector predictor of a first block based on a motion vector of at least one surrounding block of the first block;
reconstructing a motion vector for the first block based on the first motion vector predictor;
calculating a second motion vector predictor of a second block based on a motion vector of at least one surrounding block of the second block, wherein the second motion predictor is independent of the motion vector reconstructed for the first block; and
performing a motion-prediction operation for the first block and the second block independently.

The method and apparatus for encoding are involved in means, modules, processors or a software product for:

selecting a motion prediction method in which a first block and a second block can be decoded independently;

performing motion-prediction operation for the first block and the second block independently;

calculating a first motion vector predictor of a first block based on a motion vector of at least one surrounding block of the first block;

calculating a second motion vector predictor of a second block based on a motion vector of at least one surrounding block of the second block, wherein the second motion predictor is independent of the motion vector reconstructed for the first block based on the first motion vector predictor; and

encoding the first motion vector predictor and the second motion vector predictor.

Additionally, an indication to indicate the selected method is provided.

In the above methods and apparatus, the at least one surrounding block of the first block is located in a different row than the row in which the first block is located and the first block and the second block are located in the same row. Alternatively, the at least one surrounding block of the first block is located in a different column than the column in which the first block is located and the first block and the second block are located in the same column.

If either the first or the second block is coded in intra mode, an indication is used to indicate the pixel prediction for each of the pixels in the first and second blocks.

The present invention also provides an electronic device, such as a mobile phone, having a video codec as described above.

Thus, although the invention has been described with respect to one or more embodiments thereof, it will be understood by those skilled in the art that the foregoing and various other changes, omissions and deviations in the form and detail thereof may be made without departing from the scope of this invention.

What is claimed is:

1. A method of decoding an encoded video signal, comprising:
retrieving a motion prediction method indicator in the encoded video signal, the motion prediction method indicator indicative of whether or not a first block and a second block can be decoded independently;
if it is determined that the first block and the second block can be decoded in independently, the method further comprises:
calculating a first motion vector predictor of a first block based on a motion vector of at least one surrounding block of the first block;
reconstructing a motion vector for the first block based on the first motion vector predictor;
calculating a second motion vector predictor of a second block based on a motion vector of at least one surrounding block of the second block, wherein the second motion predictor is independent of the motion vector reconstructed for the first block; and
performing a motion-prediction operation for the first block and the second block independently.

2. The method of claim 1, wherein said at least one surrounding block of the first block is located in a different row than the row in which the first block is located and the first block and the second block are located in the same row.

3. The method of claim 1, wherein said at least one surrounding block of the first block is located in a different column than the column in which the first block is located and the first block and the second block are located in the same column.

4. A method of encoding a video signal, comprising:
selecting a motion prediction method in which a first block and a second block can be decoded independently;
performing motion-prediction operation for the first block and the second block in independently;
calculating a first motion vector predictor of a first block based on a motion vector of at least one surrounding block of the first block;
calculating a second motion vector predictor of a second block based on a motion vector of at least one surrounding block of the second block, wherein the second motion predictor is independent of a motion vector reconstructed for the first block based on the first motion vector predictor;
encoding the first motion vector predictor and the second motion vector predictor.

5. The method of claim 4, wherein said at least one surrounding block of the first block is located in a different row than the row in which the first block is located and the first block and the second block are located in the same row.

6. The method of claim 4, wherein said at least one surrounding block of the first block is located in a different column than the column in which the first block is located and the first block and the second block are located in the same column.

7. The method of claim 4, further comprising:
providing an indication to indicate said selecting.

8. The method of claim 7, wherein said indication indicates that entropy coding of the first block is independent of entropy coding of the second block.

9. The method of claim 7, wherein said indication is also indicative of a pixel prediction for each of a plurality of pixels in the first and second blocks if one of the first and second blocks is coded in intra mode.

10. A computer program product, embodied in a computer-readable storage medium, comprising computer codes configured to perform the method of claim 1.

11. A computer program product, embodied in a computer-readable storage medium, comprising computer codes configured to perform the method of claim 4.

12. An apparatus, comprising:
a processor; and
a memory unit communicatively connected to the processor, said memory unit comprising:
computer code for retrieving a motion prediction method indicator in the encoded video signal, the motion prediction method indicator indicative of whether or not a first block and a second block can be decoded independently; and
computer code for
calculating a first motion vector predictor of a first block based on a motion vector of at least one surrounding block of the first block;
reconstructing a motion vector for the first block based on the first motion vector predictor;
calculating a second motion vector predictor of a second block based on a motion vector of at least one surrounding block of the second block, wherein the second motion predictor is independent of the motion vector reconstructed for the first block; and
performing motion-prediction operation for the first block and the second block independently, if it is determined that the first block and the second block can be decoded in independently.

13. The apparatus of claim 12, wherein said at least one surrounding block of the first block is located in a different row than the row in which the first block is located and the first block and the second block are located in the same row.

14. The apparatus of claim 12, wherein the at least one surrounding block of the first block is located in a different column than the column in which the first block is located and the first block and the second block are located in the same column.

15. An apparatus, comprising:
a processor; and
a memory unit communicatively connected to the processor, said memory unit comprising:
computer code for selecting a motion prediction method in which a first block and a second block can be decoded independently;
computer code for performing motion-prediction operation for the first block and the second block in independently;
computer code for calculating a first motion vector predictor of a first block based on a motion vector of at least one surrounding block of the first block;
computer code for calculating a second motion vector predictor of a second block based on a motion vector of at least one surrounding block of the second block, wherein the second motion predictor is independent of a motion vector reconstructed for the first block based on the first motion vector predictor; and
computer code for encoding the first motion vector predictor and the second motion vector predictor.

16. The apparatus of claim 15, wherein said at least one surrounding block of the first block is located in a different row than the row in which the first block is located and the first block and the second block are located in the same row.

17. The apparatus of claim 15, wherein the at least one surrounding block of the first block is located in a different column than the column in which the first block is located and the first block and the second block are located in the same column.

18. The apparatus of claim 15, wherein the memory unit further comprises:
computer code for providing an indication to indicate the selected method.

19. A mobile terminal, comprising a decoding module configured for carrying out the method of claim 1.

20. A mobile terminal, comprising an encoding module configured for carrying out the method of claim 4.
